(19) United States
(12) Patent Application Publication
(10) Pub. No.: US 2025/0373488 A1
(43) Pub. Date: Dec. 4, 2025

(54) CONNECTING NETWORK DEVICES INCLUDING THE CENTRAL MANAGEMENT OF NETWORK INTERFACE CARDS TO ACHIEVE END-TO-END NETWORK CONFIGURATION CONSISTENCY

(71) Applicant: Arista Networks, Inc., Santa Clara, CA (US)

(72) Inventors: Kanzhe Jiang, Los Altos Hills, CA (US); Sandip Khushal Shah, Fremont, CA (US); Simon Capper, San Jose, CA (US); Zhao Dong, Sunnyvale, CA (US); Shunjia Yu, San Jose, CA (US)

(21) Appl. No.: 18/810,131

(22) Filed: Aug. 20, 2024

Related U.S. Application Data
(60) Provisional application No. 63/655,467, filed on Jun. 3, 2024.

(51) Int. Cl. H04L 41/0803; H04L 41/12

(52) U.S. Cl. CPC H04L 41/0803; H04L 41/12

(57) ABSTRACT

Systems and methods for network management are disclosed. Network devices are centrally managed by a network management system. In embodiments an agent can be deployed onto a network interface card at an end device or on the end device including a network interface card. The agent establishes management connectivity between a connected network element and the network interface cards at the end devices. The network management system manages both the configurations of network elements, and the configurations of the network interface cards on each end device using the network elements and the agents at the end devices.

### RELATED APPLICATIONS

This application claims the benefit of priority under 35 U.S.C. § 119 to U.S. Provisional Application No. 63/655,467 filed Jun. 3, 2024, entitled “CENTRAL MANAGEMENT OF NICS TO ACHIEVE END-TO-END NETWORK CONFIGURATION CONSISTENCY,” which is hereby fully incorporated by reference herein for all purposes.

### TECHNICAL FIELD

The disclosed embodiments relate to connecting network devices (e.g., the control and management of network devices or elements). Specifically, embodiments relate to the centralized management of network devices and elements. More particularly, disclosed embodiments relate to systems and methods for managing configurations of network elements (e.g., Network Interface Cards (NICs)) to achieve end-to-end consistency of network operations and thereby improve the performance of the networks.

### BACKGROUND

Most network computing infrastructure today consists of two groups of devices: actual network devices, such as switches, routers, firewalls (FWs), load balancers (LBs), etc.; and end devices, such as servers, storage devices, PCs, etc. End devices have network interfaces (e.g., NICs) which allow them to interact with connected network devices. While the network devices can be centrally managed through a network management system (NMS), the end devices-including the NICs of these devices—have traditionally been under the control of the devices' respective owners. The divorce between the entities involved in managing network devices and the entities managing the end devices causes issues related to connectivity or interoperability in network environments while simultaneously increasing the difficulty of accurately diagnosing such problems.

What is desired, therefore, is the capability to centrally manage both network devices and (network components of) end devices

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagram illustrating control of network connectivity across network elements and end devices in accordance with the prior art.

FIG. 2 is a diagram illustrating control of network connectivity across network elements and end devices in accordance with one or more of the disclosed embodiments.

FIG. 3 is a diagram illustrating the interconnection between a network element and a connected NIC in an end device in accordance with some embodiments.

FIG. 4 is a flow diagram illustrating an example method for deploying a NIC agent to a smart NIC and configuring the NIC in accordance with some embodiments.

FIG. 5 is a flow diagram illustrating an example of a method in which a smart NIC having an already-executing NIC agent is configured by an NMS in accordance with some embodiments.

FIG. 6 is a flow diagram illustrating an example method for maintaining configuration settings for different NIC types in corresponding profiles in accordance with some embodiments.

FIG. 7 is a flow diagram illustrating an example method for configuring NICs using corresponding profiles in accordance with some embodiments.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

As discussed, network computing infrastructure includes two groups of devices: actual network devices (e.g., responsible for the implementation of the network); and end devices-connected to those network devices and adapted to interact with those network devices via one or more network interfaces (NICs). While the network devices can be centrally managed through a network management system (NMS), the end devices—including the NICs of these devices—are usually under the control and management of the owners of those end devices. Consequently, the devices responsible for network connectivity have traditionally been managed by at least two different entities: the network device manager; and the end device manager (e.g., the owner or administrator of those devices).

End-to-end network connectivity is required, but this can only be achieved through the collaboration of the two groups of devices and the configuration of both groups of devices with an inter-operable configuration. This is difficult to achieve in practice, however, because, as discussed, the two groups of devices (network devices and end devices) are traditionally managed by different entities (e.g., administrators). This situation may impede interoperability or may introduce changes that break previously inter-operable states.

Moreover, NICs (e.g., at end devices) may experience some host errors, such as Peripheral Component Interconnect Express (PCIe) or Remote Direct Memory Access (RDMA) errors that contribute to application issues or issues at the end devices. Without end-to-end visibility, troubleshooting efforts can be non-trivial. Problems arising from incompatible configurations between network devices and end devices may also be observed on network nodes other than the changed device (the end device with the incompatibility). This leads to difficulties in efforts to troubleshoot problems arising from these incompatibilities (e.g., because problems may manifest at multiple network nodes, including those unrelated to a source of the problem). Additionally, since end devices, such as servers and storage devices, are usually managed by one or more of several different management systems, there is not any existing, practical way to centrally manage the network components (e.g., NICs) on these devices.

Rather than having multiple entities involved in the management of the end-to-end network, the disclosed embodiments establish connections between network elements and NICs of end devices so that the end-to-end connectivity of the network, including both network elements and NICs of end devices, can be centrally managed to avoid incompatibilities and inconsistent configurations that can cause errors or reduce network throughput.

In the disclosed embodiments, network devices, such as switches and routers, are centrally managed by an NMS. An agent (referred to without loss of generality as a NIC agent) can be either deployed onto the NIC if it is capable of running the agent, or the end device if the NIC is not able to host the agent itself. The agent establishes management connectivity between a network device (e.g., a connecting switch) and the NIC. The NMS manages both the configurations of network devices and the configurations of the NIC on each end device. The NMS provides the configurations for each network device, as well as the configurations for each NIC. The connecting network device (e.g., switch) for each NIC receives the configurations for both the network device and the NIC, and the NIC configuration is forwarded by the network device to the NIC. The NIC agent receives the NIC configuration and implements the NIC configuration on the NIC.

The NMS thus centrally manages the end-to-end configurations of all networking components. The configurations can include numerous different parameters, including, but not limited to, interface speed, optic settings, link negotiation mode, differentiated services code point (DSCP) settings, priority-based flow control (PFC), explicit congestion notification (ECN) settings, etc. Through this central management, the NMS can synchronize configurations between NICs and their respective connecting network devices, which can avoid errors and performance issues arising from differences between the configurations of the network devices and the NICs. The NMS can group the configurations for different network components (e.g., NICs) into various profiles based on a type of the network component, where the type of the network component may be defined by one or more characteristics such as a NIC vendor or model to ensure that inter-operable configuration between NICs and connecting network devices (e.g., switches) are consistently implemented across NICs of the same type (e.g., of the same model or from common vendors).

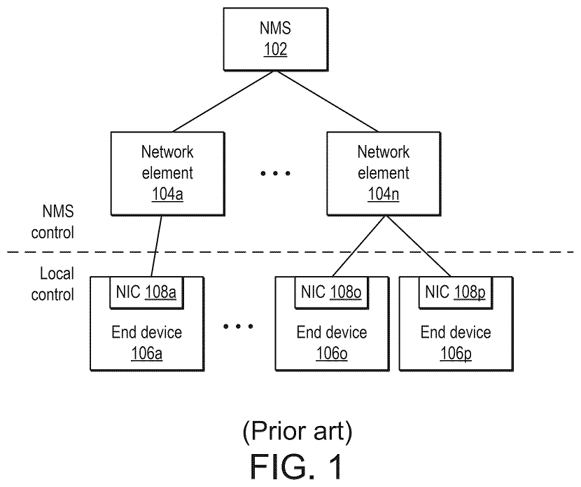

Referring to FIG. 1, a diagram is shown to illustrate the control of network connectivity across network elements and end devices in accordance with the prior art. As depicted in this figure, a plurality of network elements 104 are connected to a network management system 102. As used herein, a network element may be, for example, and without limitation, a switch, router, hub, bridge, gateway, etc., or any type of device that can communicate data packets in a network. Although the figure shows only network elements that are directly connected to the network management system, it should be noted that this is merely intended to be illustrative, and the actual network topology may be such that there are many levels of network elements, some of which are directly connected to the network management system and others which are indirectly connected to the network management system (e.g., through other network elements).

It should be noted that different instances of the same or similar devices may be identified herein by a common reference number followed by a letter. For instance, as depicted in FIG. 1, the network includes network elements 104a-104n. The individual devices may be referred to by the number and letter (e.g., network element 104a), or the devices may be referred to generically or collectively by the number alone (e.g., network elements 104).

Each of the network elements that are depicted in FIG. 1 is connected to an end device 106. End devices can be, for example, and without limitation, personal computers, laptops, servers, mobile devices (e.g., smartphones, laptops, personal digital assistants, music playing devices, gaming devices, etc.), devices capable of requesting a search or other information and/or displaying search results, or the like. Some of the network elements may be connected to a single corresponding end device, while others may be connected to multiple end devices. Each end device 106 is connected to the corresponding network element 104 via a NIC in the end device.

As noted above, network connectivity extends not only across network elements 104, but also extends to NICs 108. In traditional systems, however, NMS 102 only has management control of network elements 104—it does not have management control of NICs 108. Management control of NICs 108 is retained by the respective owners/administrators of end devices 106. Even among the NICs, there is no consolidated control, and the individual NICs may be differently configured by their respective owners/administrators.

The division of management control between the NMS-controlled network elements and the owner-controlled NICs is indicated by the dashed line in the figure. Because management responsibility is split between the NMS and the owners/administrators of the NICs, there is no end-to-end control of network connectivity, particularly by the NMS. As a result, there is no assurance that the configurations of the NICs will be consistent or compatible with the configurations of the network elements, and there may consequently be host errors, interoperability issues and reduced network performance, particularly at the network element-NIC interface.

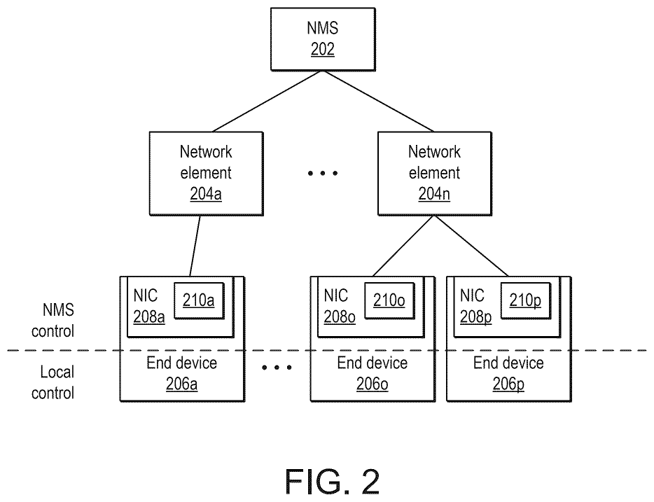

Referring to FIG. 2, a diagram is shown to illustrate the control of network connectivity across network elements and end devices in accordance with one or more of the disclosed embodiments. FIG. 2, like FIG. 1, depicts a plurality of network elements 204 (e.g., 204a, 204n) that are connected to a network management system 202, and a plurality of end devices 206 (e.g., 206a, 2060, 206p) that are connected to the network elements via corresponding NICs 208 (e.g., 208a, 2080, 208p) where a device may have one or more NICs 208). Again, although the figure shows only network elements that are directly connected to the network management system, this topology is merely illustrative. Embodiments disclosed herein may be implemented in any network topology including, for example, typologies in which a single end device 206 may have multiple NICs 208. The actual network topology may include network elements that are directly or indirectly connected to the NMS and to the network elements that are connected to the end devices through the NICs.

In the example of FIG. 2, each of the NICs in the end devices is a smart NIC that has the capability to perform functions relating to the operation of the NIC, such as receiving and implementing configuration information. Further, an NIC agent 210 (e.g., 210a, 2100, 210p) is deployed on each of the smart NICs in the end devices. The NIC agent executes on the smart NIC to expose the hardware capability of the smart NIC to the connected network element (e.g., switch). The connected network element (e.g., switch) can then provide configuration received from the NMS to the smart NIC. The system thereby enables the NMS to provide end-to-end configuration consistency across both the network elements and the NICs.

It should be noted that “smart” NIC refers to a NIC which is capable of running the NIC agent 210. A “regular” NIC is one that is not capable of running the NIC agent 210. Disclosed embodiments apply to both types of NICs. For “smart” NICs, the NIC agent is running on the NIC itself. For “regular” NICs, the NIC agent is running on the end device 206. The dashed line in FIG. 2 shows the difference in network connectivity control in comparison to the traditional system of FIG. 1. In the example of FIG. 2, the NMS has end-to-end control over the components involved in network connectivity, including network elements 204 and NICs 208. The owners/administrators of end devices 206 retain control over those devices, but they do not affect the configuration of the NICs and therefore do not introduce incompatibilities or errors that occur in traditional systems in which the owners/administrators configure the NICs.

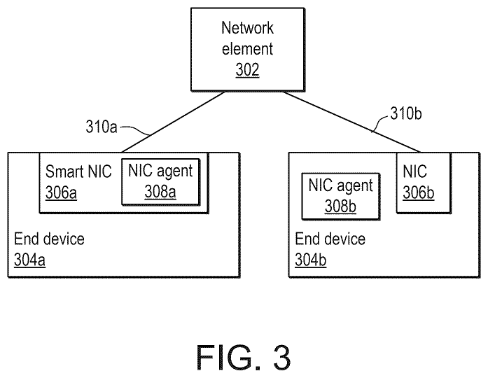

Referring to FIG. 3, a diagram is shown to illustrate the interconnection between a network element and multiple connected NICs in multiple end devices in accordance with some embodiments. Specifically, NIC 306 couples end device 304 to a network. In this example, NIC 306 is connected to a link 310, which is also connected to network element 302. In some embodiments, end device 304 can include one or more virtual machines (an emulation of a computer system by providing functionality needed to execute entire operating systems) or containers (namespace instances used for deploying and running processes without launching an entire virtual machine for each process) to allow for multiple environments which are isolated from one another, but exist on the same physical machine (e.g., end device 304). Each of the virtual machines and/or containers can include a virtual NIC that logically connects the corresponding virtual machine or container to NIC 306.

NIC 306 includes one or more interfaces that are used to transmit and receive network data over link 310. For example, the NIC may include one or more Ethernet interfaces that have data rates of, e.g., 10/100 megabits/second (Mbps), 1 gigabit/second (Gbs), or 10 Gbs. While in some embodiments, the link can be a wired connection (e.g., copper, fiber, etc.), in alternate embodiments a different type of interconnection may be used (e.g., wireless, a combination of wireless and wired, etc.). In addition, different types of protocols can be used to communicate network data over the connection (e.g., Ethernet, wireless, Synchronous Optical Networking or SONET, Fibre channel, Infiniband, etc.)

In the depicted embodiment, a network element 302 is connected to an end device 304a via a link 310a. The network element 302 can thus communicate network data with the NIC using a variety of communicating techniques (e.g., layer 2 switching, layer 3 routing, traffic shaping, applying a quality of service or QoS policy, etc.). More specifically, a port of network element 302 is connected by link 310a to a smart NIC 306a in end device 304a. In this example, smart NIC 306a executes processes using the processor and memory of the smart NIC 306a, without using the CPU, operating system, system memory, or other computing resources of end device 304a. Smart NIC 306a may use the power resources of end device 304a to power the smart NIC 306a.

A NIC agent 308a is deployed on smart NIC 306a. A smart NIC is a hardware component that can include a processor or accelerator that executes processes itself, without using the computing resources of an end device. Smart NIC 306a can, for example, process a command packet received from network element 302 without requiring any integration or support from end device 304a, and without requiring special hardware or software changes or updates to the end device. For example, the smart NIC does not require a special driver running on the end device 304a, it does not require use of a communications channel coupling the smart NIC 306a to the end device 304a, it does not need to communicate data between the smart NIC 306a and the end device 304a, it does not require a separate management channel between the smart NIC 306a and the end device 304a, and it does not require any special software or hardware changes to the end device 304a. Network element 302 (e.g., an NMS thereon) can thus communicate (e.g., directly with) NIC agent 308a through link 310a to smart NIC 306a to configure smart NIC 306a or obtain information on smart NIC 306a from NIC agent 308a installed thereon.

Network element 302 is also connected to an end device 304b via a link 310b. NIC 306b may be a “regular” NIC (i.e., not capable of running a NIC agents). Accordingly, here, NIC agent 308b is executed on end device 304b and is adapted to communicate with (e.g., “regular”) NIC 306b on end device 304b. In these types of scenarios, network element 302 may be (directly or indirectly) connected by link 310b to NIC 306b (or another network interface of end device 304b). The network element 302 may communicate with NIC agent 308b executing on end device 304b utilizing this link 310b. NIC agent 308b can thus configure NIC 306b on end device 304b in accordance with any information (e.g., configuration data) received from network element 302 (e.g., configuration data from an NMS), and may obtain information from NIC 306b and relay it to network element 302 (e.g., data intended for an NMS) through link 310b. Although not explicitly shown here, each end device 304 may have multiple NICs (including “smart” and “regular” NICs). An example of the interconnection of a network element and a NIC having a NIC agent deployed thereon is described in U.S. Pat. No. 11,310,095, issued Apr. 19, 2022, to Simon Francis Capper, which is hereby incorporated by reference in its entirety.

The NMS (see FIG. 2) manages NIC 306 (e.g., NIC 306a, 306b) through network element 302. Network element 302 may include a NIC management module that functions to communicate with NIC agent 308 to implement the NIC configuration provided by the NMS (or to obtain data from NIC 306 in accordance with instructions received from the NMS). In some embodiments, the management connectivity may be established between this NIC management module at network element 302 and NIC agent 308 on end device 304 (e.g., NIC agent 308a on NIC 306a or NIC agent 308b executing on end device 304b in communication with NIC 306b). Network element 302 may communicate (e.g., forward) a NIC configuration (or any other communications from the NMS) to NIC agent 308 via either an in-band channel or an out-of-band channel. As detailed above, the NIC agent 308a may be executing on a smart NIC 306a managed by the NMS through the NIC agent 308a and directly manager NIC 306a on which it is executing, or NIC agent 308b may be executing on end device 304b and adapted to communicate with regular NIC 306b on end device 304b to manage this regular NIC 306b in accordance with instructions received from an NMS.

The NMS may manage any of the functions of a NIC 306 through connecting network element 302. For example, the NMS and the network element 302 can access the counters of a smart NIC 306a so as to determine statistics that are maintained by smart NIC 306a (e.g., a count of the number of error packets that are received by the smart NIC 306a). The NMS and network element 302 can also apply policies to a smart NIC 306a (e.g., quality of service or QoS for traffic being transmitted via the smart NIC 306a) or apply access control lists (ACLs) to the network data being transmitted and received by a smart NIC 306a. Because any virtual NICs of the end device are resources of, for example, smart NIC 306a, if the NMS and network element 302 can manage the smart NIC 306a, they can manage any configured virtual NICs as well.

Smart NIC 306a executes NIC agent 308 that exposes the smart NIC to management by the NMS through network element 302. Network element 302 (e.g., NIC management module thereon) receives commands from the NMS and forwards the commands via link 310a to smart NIC 306a (or NIC agent 308a thereon). NIC agent 308a in smart NIC 306a receives the command, executes the command using the resources of the smart NIC 306a, and sends the results of the command back to the network element 302 if needed. The commands sent to NIC agent 308a could be, for example, a command to collect one or more different statistics kept by the smart NIC 306a (e.g., overall statistics or statistics per virtual NIC) or a command to apply a policy to the NIC 306a (e.g., QOS, ACL, policer, or another type of policy).

In a similar manner, NIC agent 308b may be executed on end device 304b where that NIC agent 308b may expose the regular NIC 306b to management by the NMS through network element 302. Network element 302 (e.g., NIC management module thereon) receives commands from the NMS and forwards the commands via link 310b to NIC agent 308b executing on end device 304b. NIC agent 308b receives the command, executes the command using the resources of the end device 304b to configure or obtain data from regular NIC 306b, and sends the results of the command back to the network element 302 if needed.

In some embodiments, the NMS can detect that a NIC is manageable (e.g., by the NMS) by sending a discovery packet through the network element to the NIC agent to which the NIC agent responds. Once the network element has received a response from the NIC agent and forwarded the response to the NMS, the NMS is aware that the NIC is manageable by the NMS. If the network element has NICs connected to multiple ports of the network element, discovery packets can be sent to each of the NICs to determine whether they are manageable by the NMS. Depending upon the response received from each NIC, the NMS can set the NIC as either manageable or unmanageable by the NMS.

In other embodiments, the network element can receive an advertisement from smart NIC 306a (e.g. NIC agent 308a on smart NIC 306a) or NIC agent 308b associated with a regular NIC 306b indicating that the NIC 306 is manageable. These advertisements or the corresponding information can be forwarded to the NMS so that the NMS is aware of which smart NICs are manageable by the NMS and which are not.

The NMS can then send commands to the manageable NICs. In some embodiments, the commands are sent to the network element, and the network element sends the commands using layer 2 encapsulated packets with a non-forwardable destination address. In some embodiments, the non-forwardable destination address is a multicast Media Access Control (MAC) address, an Internet Protocol (IP) multicast address, or an IP link local address. The NIC agent is associated with the non-forwardable address and the smart NIC forwards the packet to the NIC agent rather than the CPU of the end device. The NMS can originate the commands for the agent and the network element can send the packets. If another device coupled to the network element attempted to send a packet to the network element using this non-forwardable address, the network element would drop the packet. By restricting the agent to this non-forwardable address, devices other than the NMS and the connected network element cannot manage the NIC.

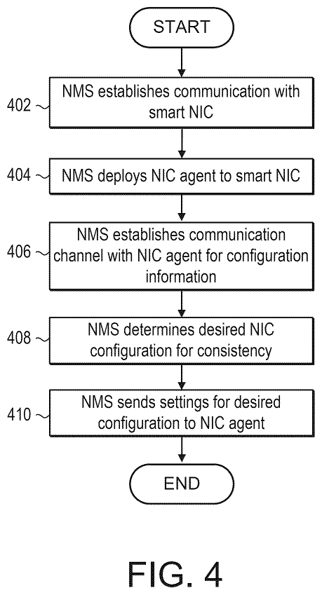

Referring to FIG. 4, a flow diagram illustrates an example method for deploying a NIC agent to a smart NIC and configuring the NIC in accordance with some embodiments. This method describes interaction between the NMS and a single smart NIC but may be repeated for all NICs in the network that are manageable by the NMS in order to achieve consistency in network communications from end-to-end (i.e., across both network elements and NICs).

At step 402, an NMS establishes communication with a particular smart NIC. Communication may be established, for example, by sending appropriate packets through the network element connected to the NIC. These packets are addressed to the smart NIC itself, rather than the end device in which the smart NIC is installed, as described above. In some embodiments, procedures may be employed to authenticate the NMS or connected network element to the smart NIC.

At step 404, when communication has been established with the smart NIC, the NMS deploys a NIC agent to the smart NIC. The NIC agent may alternatively be deployed from the connected network element without requiring the involvement of the NMS. The NIC agent may be executed on the smart NIC or on the end device itself, which facilitates control of the NIC by the NMS. At step 406, the NMS establishes communication with the NIC agent executing on the smart NIC. The NMS obtains, or has previously obtained, information about the specific type of the smart NIC (e.g., vendor, model number, etc.) and, at step 408, the NMS determines the particular configuration that is desired for the smart NIC. This configuration may, for example, synchronize the configuration of the NIC with the connected network element to facilitate network connectivity between the network element and the NIC. At step 410, the NMS provides the desired NIC configuration to the NIC via the connected network element.

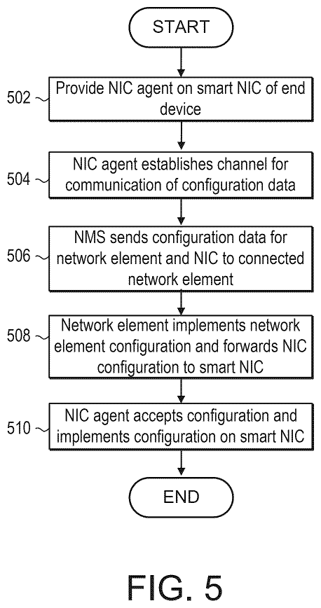

While the example of FIG. 4 involves deploying a NIC agent from the NMS to the NIC, there may already be a NIC agent executing on the smart NIC in some alternative embodiments. An example of a method in which a smart NIC having an already-executing NIC agent is configured by the NMS is shown in FIG. 5.

At step 502, an NIC agent is provided on the end device, so it is not necessary for the NMS to deploy a NIC agent to the smart NIC. At step 504, a channel for the communication of configuration data from the NMS and network element to the smart NIC is established. This communication channel can, for example, be established by the NIC agent, the NMS or some other entity in the network. At step 506, the NMS sends the network element configuration data for both the smart NIC, and the network element connected to the network element. At step 508, the connected network element implements the configuration from the NMS that is intended for the network element, and forwards the NIC configuration to the NIC agent on the smart NIC. At step 510, the NIC agent accepts the configuration data and implements the received configuration on the smart NIC.

While the NMS can manage the configuration of individual smart NICs, it is desirable to achieve end-to-end consistency in the configuration of network elements and NICs, as well as central management of the network elements and NICs. Because the specific configuration settings for a particular smart NIC depend on a number of different factors, the NMS may maintain profiles for smart NICs, where each profile corresponds to a group of smart NICs that has the same or similar characteristics and therefore uses the same configuration settings. Thus, if a smart NIC is a member of a particular group, the NMS can use the profile for that group to determine the configuration settings that need to be applied to the smart NIC. Additionally, if the configuration settings for a particular group of smart NICs needs to be updated, a corresponding change can be made to the associated profile, and the updated profile can then be applied to all of the smart NICs in the group to maintain configuration consistency.

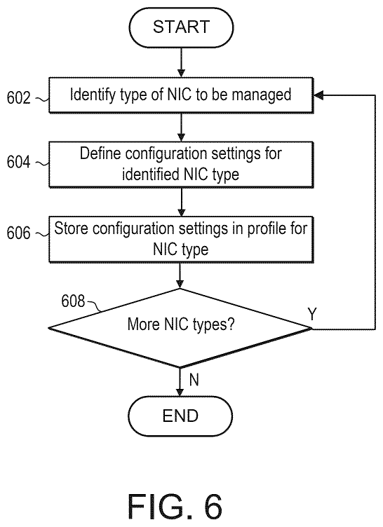

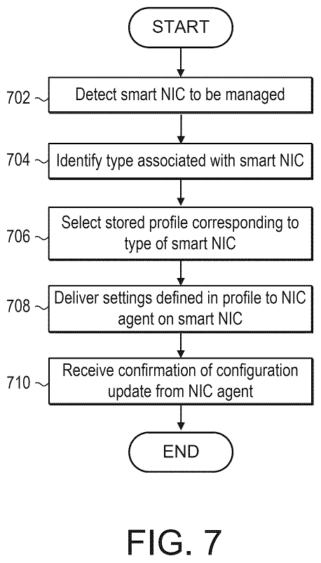

This is illustrated in FIGS. 6 and 7. FIG. 6 is a flow diagram illustrating an example method for maintaining configuration settings for different NIC types in corresponding profiles. FIG. 7 is a flow diagram illustrating an example method for configuring NICs (e.g., smart NICs or regular NICs) using corresponding profiles.

Referring to FIG. 6, at step 602 the NMS identifies a type of NIC that is being managed. At step 604, the NMS defines the configuration settings that are to be implemented in NICs of the identified type. At step 606, the NMS stores the configuration settings for the identified NIC type in a profile. At step 608, the NMS determines whether there are any additional types of NICs for which profiles need to be created. If so, the method returns to step 602 and defines and stores a profile for the next NIC type. If not, the method ends.

Referring to FIG. 7, at step 702, the NMS detects a particular NIC that is to be managed by the NMS. This detection may be the result of a discovery message sent by the NMS or an advertisement message sent from a NIC agent (e.g., on a smart NIC or on an end device and adapted to manage a regular NIC on the end device). At step 704, the NMS identifies the type of the NIC. Then, at step 706, the NMS selects from a set of stored profiles the specific profile that corresponds to the identified type of the NIC. At step 708, the NMS delivers the configuration settings that are defined in the profile to the NIC agent adapted to manage the NIC (e.g., running on a smart NIC or on the end device including a regular NIC). After the NIC agent implements the configuration settings on the NIC, the NMS may receive confirmation of the updated configuration from the NIC agent (step 710).

It will be understood that while specific embodiments have been presented herein, these embodiments are merely illustrative, and not restrictive. Rather, the description is intended to describe illustrative embodiments, features and functions in order to provide an understanding of the embodiments without limiting the disclosure to any particularly described embodiment, feature or function, including any such embodiment feature or function described. While specific embodiments of, and examples for, the embodiments are described herein for illustrative purposes only, various equivalent modifications are possible within the spirit and scope of the disclosure, as those skilled in the relevant art will recognize and appreciate.

As indicated, these modifications may be made in light of the foregoing description of illustrated embodiments and are to be included within the spirit and scope of the disclosure. Thus, while particular embodiments are described, a latitude of modification, various changes and substitutions are intended in the foregoing disclosures, and it will be appreciated that in some instances some features of embodiments disclosed herein will be employed without a corresponding use of other features, and features described with respect to one embodiment may be combined with features of other embodiments without departing from the scope and spirit of the disclosure as set forth herein.

What is claimed is:

1. A method for centrally managing network interfaces at end devices in a network, comprising:
establishing, by a first agent at a first end device, management connectivity between a network element in a network and a first network component at the first end device;
receiving, at the network element, a first configuration from a network management system managing the network; and
forwarding the first configuration from the network element to the first network component at the first end device using the established management connectivity between the network element and the first network component such that the first configuration is implemented on the network component at the first end device.

2. The method of claim 1, wherein the network element is a switch.

3. The method of claim 1, wherein the network component comprises a network interface card (NIC).

4. The method of claim 3, wherein the agent is executing on the NIC.

5. The method of claim 3, wherein the agent is executing on a processor of the network element.

6. The method of claim 1, wherein a second configuration is received at the network element from the network management system, the second configuration including a configuration for the network element.

7. The method of claim 6, wherein the second configuration is received with the first configuration.

8. The method of claim 1, wherein the first configuration includes one or more of an interface speed, an optic setting, a link negotiation mode, a differentiated services code point (DSCP) setting, a priority-based flow control (PFC) setting, or an explicit congestion notification (ECN) setting.

9. The method of claim 1, further comprising forwarding the first configuration from the network element to a second network component at a second end device using established management connectivity between the network element and the second network component such that the first configuration is implemented on the second network component at the second end device.

10. The method of claim 9, wherein the first configuration is associated with a type of network component and both the first network component and the second network component are that type of network component.

11. A system, comprising:
a network management system adapted to manage network devices and end device sin a network, the network management system adapted for sending a first configuration associated with an end device to network elements in the network;
a network element connected to an end device comprising a NIC and having an agent installed thereon, the network element comprising a NIC management module adapted for:
establishing management connectivity with the agent at the end device;
receiving the first configuration from the network management system;
forwarding the first configuration to the agent at the end device using the established management connectivity such that the first configuration is implemented on the NIC.

12. The system of claim 11, wherein the network management system is further adapted for determining the first configuration based on a type of the NIC.

13. The system of claim 11, wherein the NIC is a smart NIC and the agent executes on a processor of the NIC.

14. The system of claim 11, wherein the network management system is further adapted to discover the end device is manageable.

15. The system of claim 14, wherein discovering the end device is manageable comprises sending a discovery packet to the end device.

16. The system of claim 14, wherein discovering the end device is manageable comprises receiving an advertising message from the agent at the end device.

17. The system of claim 11, wherein the configuration comprises a policy of an access control list.

18. A method for centrally managing network interfaces at end devices in a network, comprising:
deploying an agent to a smart NIC at an end device in a network;
establishing management connectivity between the agent and a network element connected to the end device; and
providing a configuration from a network management system to the agent on the smart NIC at the end device, wherein the configuration is received at the connected network element and provided from the connected network element using the established management connectivity such that the configuration is implemented by the agent on the smart NIC at the end device.

19. The method of claim 18, wherein the agent was deployed from the network element or the network management system.

20. The method of claim 19, wherein the configuration synchronizes a configuration of the smart NIC with a configuration of the connected network element.
